(19) United States
(12) Patent Application Publication
(10) Pub. No.: US 2010/0044058 A1
(43) Pub. Date: Feb. 25, 2010

(54) NON-COLLAPSIBLE FOAM EXTENSION HOSE

(76) Inventors: Mark A. Cummins, Burleson, TX (US); Lisa Yvette Lafosse, Crowley, TX (US)

Correspondence Address: Mark A. Cummins, 473 Wildwood Lane, Burleson, TX, 76028, US

(21) Appl. No.: 12/502,045

(22) Filed: Jul. 13, 2009

Related U.S. Application Data
(60) Provisional application No. 61/134,554, filed on Jul. 11, 2008.

(51) Int. Cl. A62C 31/00; F16L 11/00

(52) U.S. Cl. 169/5; 138/120

(57) ABSTRACT

A firefighting device adapted to discharge a fluid to put out a fire may include a hose connected to a source of the fluid, including: a collapsible section connected to the source of the fluid; and a non-collapsible section connected to the collapsible section adapted to discharge the fluid. The non-collapsible section may be connected to a valve to turn off and turn on the fluid, and the valve may be a break apart nozzle. The fluid may be a foam agent, and the source may be a fire engine truck. The length of the non-collapsible section maybe substantially between 2 feet and 10 feet.

### PRIORITY

The present invention claims priority under 35 USC section 119 based upon a provisional application which was filed on Jul. 11, 2008 with a Ser. No. 61/134,554

### FIELD OF THE INVENTION

The present invention relates to hoses and more particularly to a fireman's hose for foam which may include a substantially non-collapsible hose section and a compressible hose section.

### BACKGROUND

Through the ages, water has been used as the method to extinguish all types of fires. When there is a fire call, the responding department takes its fire engine filled with water, and the standard woven fire hose which is collapsible, is used to deliver the water. Water is substantially not compressible, especially under pressure and the standard woven fire hose remains substantially rigid due to the pressurized water. This rigid, water filled hose should generally maintain a passageway for the water to flow and may not be normally susceptible to crushing, kinking or disruption by the fire fighter while maneuvering the fire hose.

One of the more difficult and dangerous functions of interior structure fire fighting requires that fire-fighting personnel be in close proximity with the fire to extinguish the fire. In this dangerous situation, the fire fighter will require increased maneuverability and flexibility of the hose, in order to direct the water stream in as many positions and directions as necessary to cover the entire room and contents involved in the fire with water from the hose of the fireman.

In Mar. 9, 1982, a new invention, titled ‘Foam Generating Fire Fighting Device’, U.S. Pat. No. 4,318,443, also known as CAFS (Compressed Air Foam (System), was developed. This new method of generating foam includes compressible gasses, such as air, Nitrogen, Helium, Argon, Halogenated gas, Freon, Carbon Dioxide, or combinations of any compressible gas.

CAFS has proven to be far more effective than previous water in fire fighting applications. This compressible foam flow has caused a new problem with the standard compressible soft woven fire hose, designed to deliver non compressible water. The combination of the compressible foam and the compressible hose results in a CAFS method of generating foam that is susceptible to foam degradation caused by crushing, or kinking of the hose, in close vicinity fire fighting conditions, such as interior structural fire fighting. If the hose is turned away from a straight line, the hose may kink or collapse, reducing or eliminating the flow of foam. Alternatively, this kinking or crushing may cause breaking of the bubbles in the foam, releasing the beneficial gasses before they reach the fire, and otherwise disrupting smooth flow of the foam through the foam discharge end of a standard woven fire hose. This defeats the advantages of the bubble structure as a carrier of the fire suppressant gasses and liquids in the form of foam.

There are many prior art devices which are employed to be used in the aid of fire fighting, but none that promote safety with the typical woven fire hose filled with a Compressed Air Foam fluid. Normal fire fighting hoses appear to be too soft to support the compressed air foam and its use in a close vicinity fire attack.

Kinking of the standard woven fire hose can degrade the foam discharge, which can immediately cause a very dangerous condition for the fire fighter in an interior fire fight. This standard woven fire hose is generally light weight and easy to deploy and remove.

### SUMMARY

A firefighting device adapted to discharge a fluid to put out a fire may include a hose connected to a source of the fluid, including: a collapsible section connected to the source of the fluid; and a non-collapsible section connected to the collapsible section adapted to discharge the fluid.

The non-collapsible section may be connected to a valve to turn off and turn on the fluid, and the valve may be a break apart nozzle.

The fluid may be a foam agent, and the source may be a fire engine truck.

The length of the non-collapsible section maybe substantially between 2 feet and 10 feet.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view of the system of the present invention;

FIG. 2 illustrates a cross-sectional view of the system of the present invention.

### DETAILED DESCRIPTION

To prevent this kinking and foam degradation, the present invention proposes a solution, which is a section of non-collapsible hose which may be used in combination with a collapsible hose. The non-collapsible hose may be positioned where most of the kinking may occur, namely at the end of the hose that the firefighter is using to discharge the foam. The non-collapsible hose may be shorter than the collapsible hose in order to retain the advantages of lightweight and ease of deployment. The collapsible hose does not result in reduced effectiveness of the foam as it is being applied. The non-collapsible hose may be sufficiently flexible to be turned or rotated without affecting the characteristics of the foam. The present invention may refer to this non-collapsible hose as a Non-Collapsible Foam Extension Hose. This Non Collapsible Foam Extension Hose may be a predetermined length of flexible, kink-resistant hose, capable of having a memory in order to regain or return to the original shape after being deformed which may have been caused by crushing or twisting. The Non-Collapsible Foam Extension Hose may be formed from material found in either, the Niedner Reel-Tex hose, Canadian Patent No. 2168497, or any other non-collapsible type of hose that would accomplish the same purpose as the Niedner brand of non-collapsible type hose.

The Non-Collapsible Foam Extension Hose may detachably connect to the discharge end of the standard soft woven fire hose. The typical length for standard collapsible fire hose may be in 50′ (foot) lengths, and 100′ (foot) lengths which may collapse and lay flat when stored on board the fire truck.

The Non-Collapsible Foam Extension Hose may be formed in any size length but may be formed in a length which is substantially less than the collapsible fire hose where example may be formed in a predetermined lengths from 2′ (foot) lengths, to 10′ (foot) lengths. Shorter lengths of the non collapsible hose may be used to reduce the cost and improve bulk storage of the non collapsible hose in limited storage areas of the fire trucks.

This Non-Collapsible Foam Extension Hose should provide a full flow, stable foam discharge and easy maneuverability, which will improve safety and effectiveness for the fire fighter/nozzle man, while eliminating the danger of kinking, or crushing of the compressible hose at the discharge end of the standard soft woven fire hose, while improving fire suppression capabilities of the foam discharge.

A full flow break-a-part nozzle (shut off valve) may be connected to the discharge end of the Non-Collapsible Foam Extension Hose for control of the foam discharge.

The diameter of the Non-Collapsible Foam Extension Hose may be selected to cooperate with the diameter of standard fire and industrial hoses, with diameters from 1″ (inches) to 6″ (Inches) or other appropriate diameter. These specifications may depend on the needs of the service industry, and the compressed air foam application. The Non Collapsible Foam Extension Hose may be formed with appropriate connectors or couplings that may allow connection to other couplings or connections that may be used for fire or industrial applications, that will fit the selected diameter of the Non-Collapsible Foam Extension Hose produced. These couplings or connections may include the standard industrial type male and female couplings on the ends of the non-collapsible foam extension hose and the collapsible hose, and will be attached at the time of production, or in the field with special fittings that accomplish the same purpose. The Non-Collapsible Foam Extension Hose may be selected to match your cooperate with the diameter of the non-collapsible hose.

Examples of fittings, couplings or connectors are the industrial cam lock fittings, fire department National Standard Threads (NST), fire department Stortz fittings, and Iron Pipe Thread (IPT).

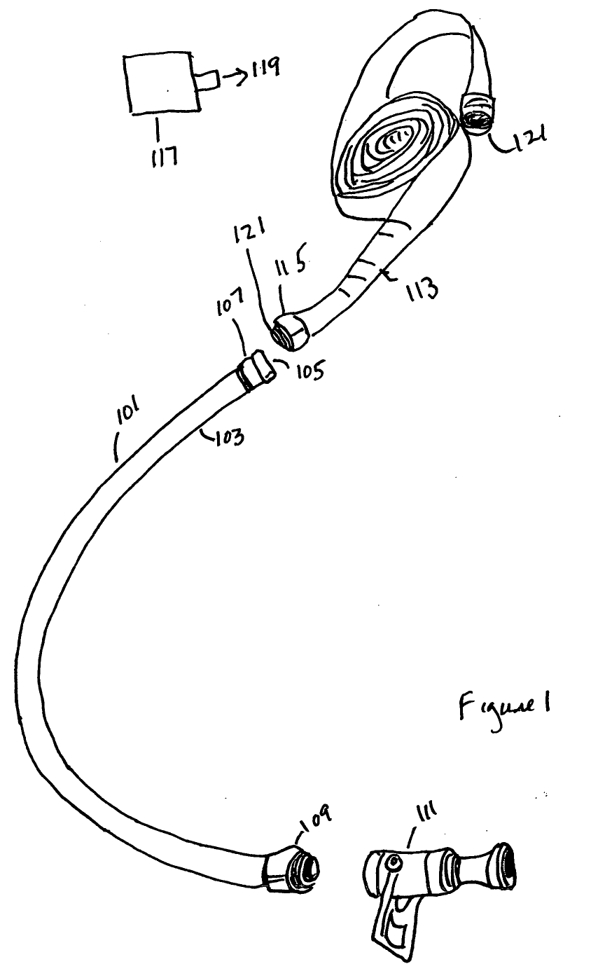

FIG. 1 illustrates an exploded view of the system of the present invention and illustrates a non-collapsible hose section 101 which may be referred to as a non-collapsible foam extension hose which may be an elongated cylinder 103 which may include a central passageway 105 which may extend the entire length of the non-collapsible hose section 101. The non-collapsible hose section 101 is shown as a substantial cylinder however, other shapes such as elliptical are within the scope of the present invention. The central passageway 105 may include a circular cross-section or may have other shape cross-section such as oval, rectangular or other appropriate cross-sections. The non-collapsible hose section 101 may include a first connector 107 at a distal end of the non-collapsible hose section 101 and a second connector 109 at a proximal end of the non-collapsible hose section 101. The non-collapsible hose section 101 may operate without the second connector 109. The non-collapsible hose section 101 may be connected to a valve member 111 at the second connector 109. The valve member 111 may be any type of valve to facilitate the dispensing of the foam agent.

The non-collapsible hose section 101 may be connected to a compressible hose section 113 at the first connector 107 and may cooperate with a third connector 115 to form a connection which may be substantially fluid tight with the compressible hose section 113. FIG. 1 additionally illustrates a foam agent generator 117 to generate the foam agent 119 which may be foam adapted to put out fires, and the foam agent generator 117 which may be a fire truck or other type of firefighting equipment may generate the foam agent 119 under pressure. The distal end of the compressible hose section 113 may be connected to an outlet of the foam agent generator 117 and may include a passageway 121 for the foam agent to be conducted through the compressible hose section 113 and conducted through a passageway 105 of the non-collapsible hose section 101 and to be dispensed from either the non-collapsible hose section 101 or alternatively from the valve member 111

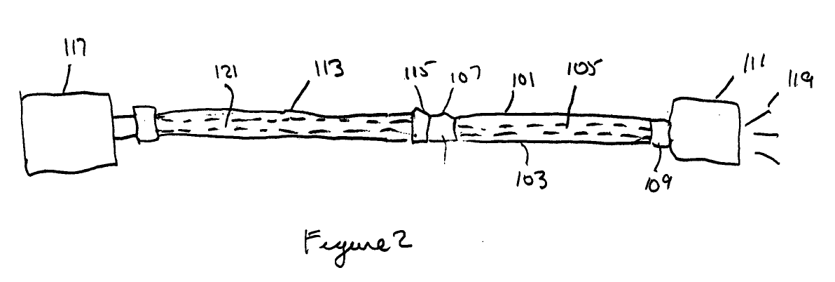

FIG. 2 illustrates a cross-sectional view of the system of the present invention and illustrates a non-collapsible hose section 101 which may be referred to as a non-collapsible foam extension hose which may be an elongated cylinder 103 which may include a central passageway 105 which may extend the entire length of the non-collapsible hose section 101. The non-collapsible hose section 101 is shown as a substantial cylinder however, other shapes such as elliptical are within the scope of the present invention. The central passageway 105 may include a circular cross-section or may have other shape cross-section such as oval, rectangular or other appropriate cross-sections. The non-collapsible hose section 101 may include a first connector 107 at a distal end of the non-collapsible hose section 101 and a second connector 109 at a proximal end of the non-collapsible hose section 101. The non-collapsible hose section 101 may operate without the second connector 109. The non-collapsible hose section 101 may be connected to a valve member 111 at the second connector 109. The valve member 111 may be any type of valve to facilitate the dispensing of the foam agent.

The non-collapsible hose section 101 may be connected to a compressible hose section 113 at the first connector 107 and may cooperate with a third connector 115 to form a connection which may be substantially fluid tight with the compressible hose section 113. FIG. 1 additionally illustrates a foam agent generator 117 to generate the foam agent 119 which may be foam adapted to put out fires, and the foam agent generator 117 which may be a fire truck or other type of firefighting equipment may generate the foam agent 119 under pressure. The distal end of the compressible hose section 113 may be connected to an outlet of the foam agent generator 117 and may include a passageway 121 for the foam agent to be conducted through the compressible hose section 113 and conducted through a passageway 105 of the non-collapsible hose section 101 and to be dispensed from either the non-collapsible hose section 101 or alternatively from the valve member 111

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A firefighting device adapted to discharge a fluid to put out a fire, comprising:
a hose connected to a source of the fluid, including:
a collapsible section connected to the source of the fluid;
a non-collapsible section connected to the collapsible section adapted to discharge the fluid.

2) A firefighting device adapted to discharge a fluid to put out a fire as in claim 1, wherein the non-collapsible section is connected to a valve to turn off and turn on the fluid.

3) A firefighting device adapted to discharge a fluid to put out a fire as in claim 2, wherein the valve is a break apart nozzle.

4) A firefighting device adapted to discharge a fluid to put out a fire as in claim 1, wherein the fluid is a foam agent.

5) A firefighting device adapted to discharge a fluid to put out a fire as in claim 1, wherein the source is a fire engine truck.

6) A firefighting device adapted to discharge a fluid to put out a fire as in claim 1, wherein the length of the non-collapsible section is substantially between 2 feet and 10 feet.
